(19) United States
(12) Patent Application Publication
(10) Pub. No.: US 2024/0373771 A1
(43) Pub. Date: Nov. 14, 2024

(54) DIGGING TOOL AND METHOD OF MAKING THEREOF

(71) Applicant: Arman Mazdiyasni, San Diego, CA (US)

(72) Inventor: Arman Mazdiyasni, San Diego, CA (US)

(21) Appl. No.: 18/197,052

(22) Filed: May 13, 2023

(51) Int. Cl. A01B 1/02; B21D 53/66

(52) U.S. Cl. CPC A01B 1/02; B21D 53/66

(57) ABSTRACT

A tool that may be used for digging or excavation, the tool includes a blade with a lower edge, an upper edge configured to attach to, or secure to, at least one of: a handle, machine, or other tool. The tool blade further includes left and right side edges integrally connecting the lower edge and the upper edge to form a surface. The tool blade further includes a notch that may be formed on at least one of: a left side edge, a right side edge, or the lower edge of the blade, the notch being configured to have a top surface and at least one side surface. The notch may extend inwards from a peripheral edge of the surface of the blade.

### FIELD OF THE DISCLOSURE

The embodiments described herein relate to tools and hardware, and in particular, a digging tool and method of making the digging tool for removing, cutting, and unearthing matter while avoiding or preventing damage to surface level or buried objects, obstacles, and obstructions.

### BACKGROUND

Presently many tools exist for digging and excavation projects to help unearth, remove, cut, separate or pierce through soil, rock, roots, debris, obstacles, and obstructions. However, only in recent years have digging or excavation tools been manufactured in numerous shaped blades, blade lengths, and blade curvatures to provide users with added functionality besides removing soil, water, debris, or snow. For example, the digging tool blade has been modified for many different applications, such as using sifting blades for easier soil removal in muddy or wet terrain, cutting teeth blades for better piercing function to cut through roots, weeds and rocks, better blade reinforcements for better durability and consistent trench or pit formation, lightweight designs for more efficient usage, as well as many other functionalities. However, the tool blade itself is generally constructed for the purpose of effectively removing, cutting, and unearthing matter and not for avoiding or preventing damage to surface level or buried objects, obstructions, obstacles, utility lines, and the like. Moreover, the tool blade can also become damaged from striking solid or rigid objects during use in digging or excavation. Further, tool blades are difficult to use when digging or excavating soil, debris, and other matter alongside a surface level or buried obstacle or utility line, and the like.

### SUMMARY

The disclosed subject matter relates to a digging tool including a blade having a lower edge, an upper edge configured to attach to at least one of a handle, a machine, or other tool, and left and right side edges integrally connecting the lower edge and the upper edge to form a surface. The digging tool further includes a notch formed on at least one of: a left side edge, a right side edge, or the lower edge of the blade, the notch being configured to have a top surface and at least one side surface, the notch extending inwards from a peripheral edge of the surface of the blade.

The disclosed subject matter relates to a shovel blade including an upper edge, a lower edge, and left and right side edges integrally connecting the upper edge and lower edge to form a surface. The shovel blade further includes a notch extending from at least one of: a left side edge, a right side edge, or the lower edge towards the upper edge, the notch being configured to have a top surface and at least one side surface, the notch extending inwards from an outer edge of the surface of the blade.

The disclosed subject matter further relates to a method of making a shovel blade for avoiding obstacles in shoveling, the method includes forming a blade configured to have at least an upper edge, a lower edge, and left and right side edges integrally connecting the upper edge and lower edge to form a surface, forming a notch on at least one of: a left side edge, a right side edge, or the lower edge of the blade, and forming a top surface and at least one side surface for the notch, wherein at least a portion of the notch extends inwards from a peripheral edge of the surface of the blade.

It is understood that other configurations of the present disclosure will become readily apparent to those skilled in the art from the following detailed description, wherein various configurations of the present disclosure are shown and described by way of illustration. As will be realized, the present disclosure of other different configurations and its several details are capable of modifications in various other respects, all without departing from the subject technology. Accordingly, the drawings and the detailed description are to be regarded as illustrative in nature and not restrictive.

### BRIEF DESCRIPTION OF THE DRAWINGS

Certain features of the present disclosure are set forth in the appended claims. However, for purpose of explanation, several implementations of the present disclosure are set forth in the following figures.

FIG. 1A illustrates a front perspective view of an example digging tool in accordance with one or more embodiments of the present disclosure.

FIG. 1B illustrates a front perspective view of an example digging tool in accordance with one or more embodiments of the present disclosure.

FIG. 1C illustrates a front perspective view of an example digging tool in accordance with one or more embodiments of the present disclosure.

FIG. 1D illustrates a front perspective view of an example digging tool in accordance with one or more embodiments of the present disclosure.

FIG. 1E illustrates a front perspective view of an example digging tool in accordance with one or more embodiments of the present disclosure.

FIG. 1F illustrates a front perspective view of an example digging tool in accordance with one or more embodiments of the present disclosure.

FIG. 1G illustrates a front perspective view of an example digging tool in accordance with one or more embodiments of the present disclosure.

FIG. 1H illustrates a front perspective view of an example digging tool in accordance with one or more embodiments of the present disclosure.

FIG. 2A illustrates a front view of an example blade for digging, unearthing, or excavation in accordance with one or more embodiments of the present disclosure.

FIG. 2B illustrates a front view of an example blade for digging, unearthing, or excavation in accordance with one or more embodiments of the present disclosure.

FIG. 2C illustrates a front view of an example blade for digging, unearthing, or excavation in accordance with one or more embodiments of the present disclosure.

FIG. 2D illustrates a front view of an example blade for digging, unearthing, or excavation in accordance with one or more embodiments of the present disclosure.

FIG. 2E illustrates a front view of an example blade for digging, unearthing, or excavation in accordance with one or more embodiments of the present disclosure.

FIG. 2F illustrates a front view of an example blade for digging, unearthing, or excavation in accordance with one or more embodiments of the present disclosure.

FIG. 3A illustrates a front perspective view of an example blade with an example protective guard in accordance with one or more embodiments of the present disclosure.

FIG. 3B illustrates a front perspective view of an example blade with an example protective guard in accordance with one or more embodiments of the present disclosure.

FIG. 3C illustrates a front perspective view of an example blade with example protective guards in accordance with one or more embodiments of the present disclosure.

FIG. 4 illustrates an example flow chart showing a method of making an example blade for digging, shoveling, or excavation in accordance with one or more embodiments of the present disclosure

FIG. 5 illustrates an example flow chart showing a method of making an example blade fitting having a blade for digging, shoveling, or excavation in accordance with one or more embodiments of the present disclosure.

FIG. 6 illustrates an example flow chart showing a method of making an example digging tool in accordance with one or more embodiments of the present disclosure.

Embodiments of the present disclosure and their advantages are best understood by referring to the detailed description that follows. It should be appreciated that like-reference-numerals are used to identify like-elements illustrated in one or more of the figures.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to better illustrate details and features of the present disclosure.

Various features of the present disclosure will now be described and is not intended to be limited to the embodiments shown herein. Modifications to these features and embodiments will be readily apparent to those skilled in the art, and the principles defined herein may be applied to other embodiments without departing from the scope of the disclosure.

In the following detailed description, numerous specific details are set forth by way of examples in order to provide a thorough understanding of the relevant teachings. However, it should be apparent that the present teachings may be practiced without such details. In other instances, well known methods, procedures, components, and/or processes have been described at a relatively high-level, without detail, in order to avoid unnecessarily obscuring aspects of the present teachings.

Many digging tools have been manufactured for the purpose of effectively removing, cutting, and unearthing matter and not for avoiding or preventing damage to surface level or buried objects, obstructions, obstacles, utility lines, and the like. The tool blades for these digging tools are also not designed to withstand damage from inadvertent striking of solid or rigid objects during use in digging or excavation. Moreover, the tool blades are difficult to use when digging or excavating soil, debris, and other matter alongside a surface level or buried obstacle or utility line, and the like. Further, the tool blades are inconvenient if not difficult to sharpen or replace. Various embodiments of the present disclosure provide a solution to one or more of the above technical problems and others. In one embodiment, a brace device, for providing proper chin, limb, neck, or head support and posture includes a rest surface for resting a chin, limb, neck or head of a wearer, the rest surface is supported by a stand surface and a connecting structure. To facilitate positioning and support the brace device on the body of the wearer, the brace device may include a band and an attachment means provided on the stand surface for securing the band to the stand surface, the band and attachment means being used to secure the brace device to the body of the wearer. In some embodiments, one or more aspects of the blade designs may be readily applied to various digging machines and devices, for example, bulldozers and snow plows. These and other embodiments are described in the present disclosure for providing a solution to one or more of the above technical problems and others, thereby allowing individuals to use one or more digging tools, blades, or machines that protects surface level and buried obstacles, obstructions, plumbing. utility lines, and the like.

The terms guard, padding, or protection may be used interchangeable in the present disclosure and may refer to a region on a blade that protects at least one of: the blade surface from damage, the blade function from being damaged (e.g., damaging a sharp edge of the blade needed for piercing), or the surface or buried obstruction(s) from being damaged. Moreover, the terms obstruction, object, obstacles, debris, utility lines, service lines, and plumbing may be used interchangeable in the present disclosure and may refer to a surface level or buried material or matter that is desired to keep protected from scratching, cutting, or otherwise damaging its surface. Further, the term digging, digging tool, excavation, shoveling, or unearthing should not be limited to, for example, the removal of soil, debris, or earth and may be easily and readily be applied to removal of excess or unwanted material from any surface using a blade or tool to remove matter or material from the surface. For example, a blade of the present disclosure may be used to remove excess material on a glass surface having obstructions (e.g., rods, pipes, fittings) that extend through the surface and between the terminal edges of the glass surface.

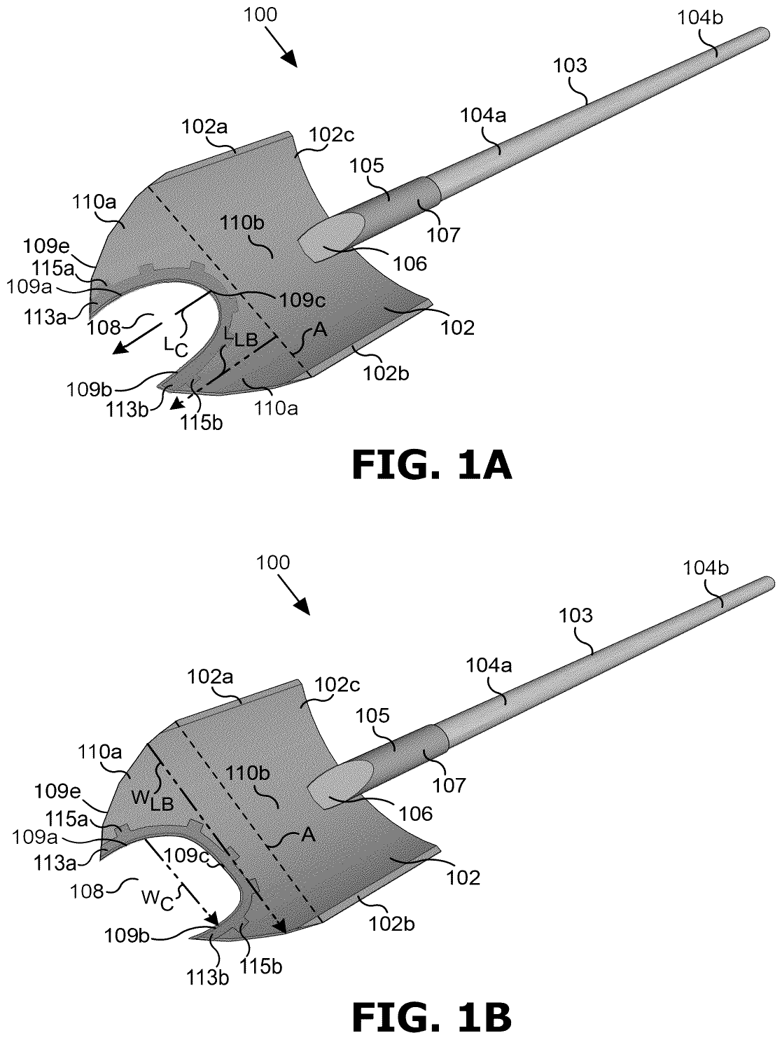

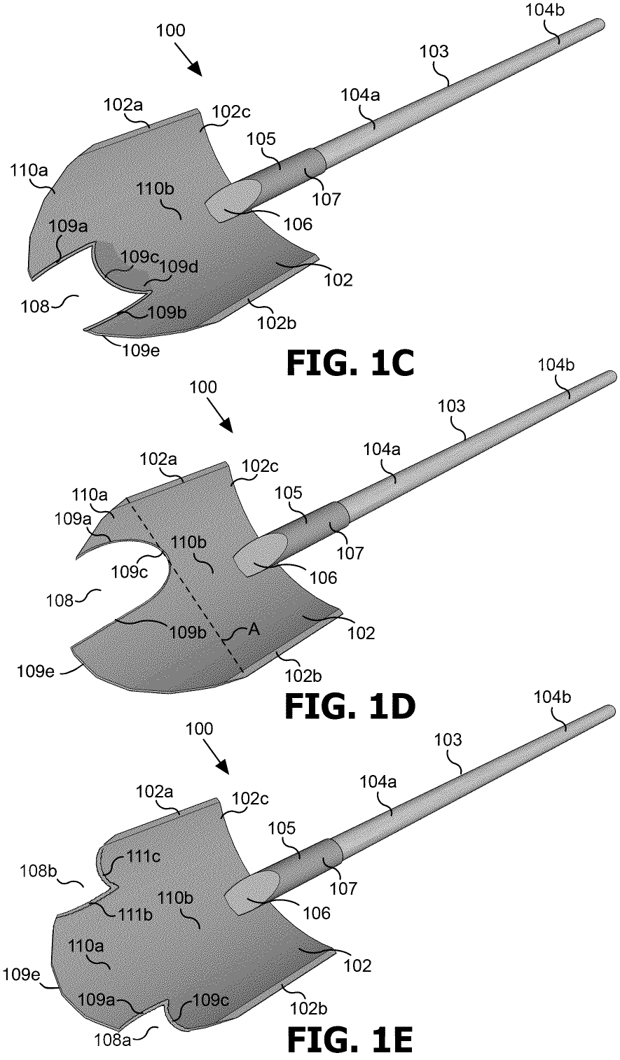

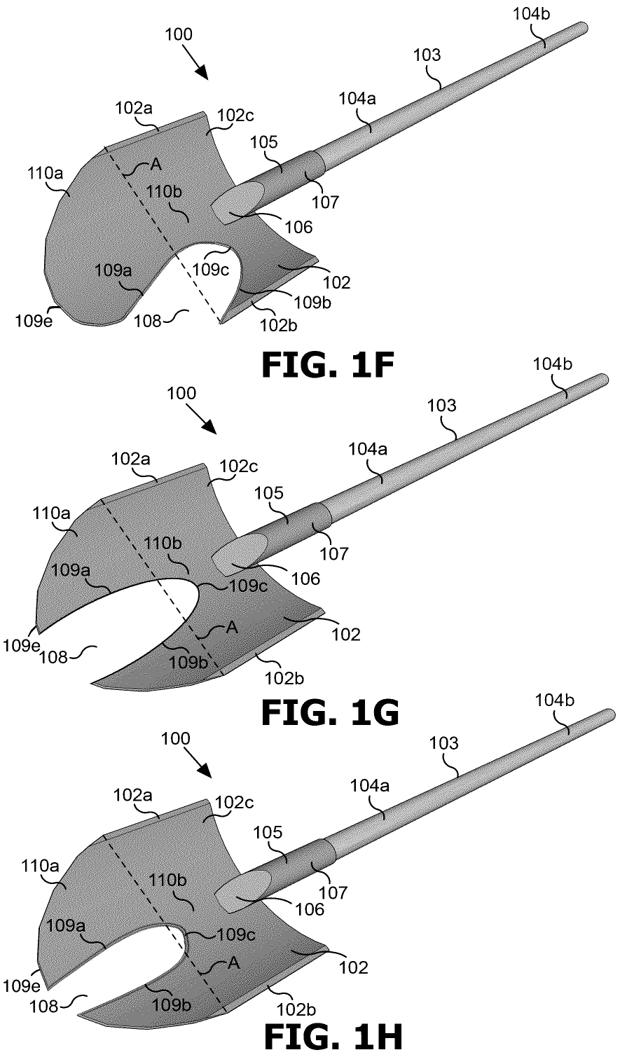

FIGS. 1A-1H illustrate a front perspective view of an example digging tool in accordance with one or more embodiments of the present disclosure. As shown in FIGS. 1A-1H, the digging tool 100 may include a collar 105 coupling a blade 102 to a handle 103. The handle 103 may include a lower portion 104a and an upper portion 104b. The collar 105 may include a lower surface 106 adjacent to a first end and an upper surface 107 adjacent to a second end. The blade 102 may include a lower body 110a, an upper body 110b, right side edge 102a, left side edge 102b, and an upper edge 102c. The lower body 110a and the upper body 110b may be divided by at an interface A. In many embodiments, on the blade 102 may be formed at least one notch or opening 108 having boundaries defined by at least one of: a lower body 110a, an upper body 110b, right side edge 102a. left side edge 102b, and an upper edge 102c. The opening 108 may include an upper boundary 109c, at least one side boundary 109a and 109b. As shown in FIG. 1C, the blade 102 may further include an at least one contour surface regions 109d formed between the lower body 110a and the upper body 110b having a different curvature or incline from at least one of the lower body 110a and the upper body 110b.

In some embodiments, the collar 105 may be a cylinder or rod to receive or fit a handle 103. In certain embodiments, the collar and handle may be a single piece that forms the handle 103 for the digging tool 100. In many embodiments, the collar 105 may be a cylinder that attaches the blade 102 to at least one of a handle, a machine, or other tool. In some embodiments, the blade 102 may attach directly to a handle, a machine, or other tool. Although a blade 102 in the present disclosure is described in certain embodiments as being attached to a tool, or forming a digging tool, it is by way of example and not by limitation, and as such, a blade 102 can also be formed for, and/or attached to, any other tool (e.g., trowel, saw, etc.,) or machine (e.g., bulldozer, snow plow, thatcher tool, etc.,). Thus, disclosure for the embodiments described in the present invention for a blade may be instantly applied to any other blade for another tool or a machine as desired.

In some embodiments, the interface A forms the boundary between the lower body 110a and the upper body 110b. In certain embodiments, additional interfaces may be added as needed to divide lower body, upper body, left side edge, and right side edge to provide areas for digging, piercing, scooping, holding, etc., as well as one or more openings for preventing damage to surface level or buried obstacles or obstructions. For example, as shown in FIG. 1C, an example blade 102 may include one or more regions 109d having the same, similar, or different surface contour as lower body 110a or upper body 110b to facilitate better digging or scooping. Further, as shown in FIG. 1D, the example blade 102 may be divided into quadrants separating piercing (side boundary 109a) and damage prevention (opening 108) from digging and scooping functions (lower body 110a). Moreover, as shown in FIG. 1E one or more openings 108a may cut into the side edges 102a or 102b of the blade 102 and extend into the blade 102 below or above interface A. Further, as shown in FIG. 1F, one or more openings 108 may extend at an angle along a side edge 102a of the blade 102 above interface A.

The example opening 108 of the digging tool 100 may include at least one of a parabolic, elliptical, or circular shape having an upper boundary 109c and side boundaries 109a, 109b. An interface A may divide the upper body 110b from the lower body 110a, and at least one opening 108 may be formed below the interface A. The opening 108 may include a cut-out length L_{C} extending into the blade 102 by between approximately 2″ to 18″. Further, the lower body 110a may include a length L_{LB} extending from the upper edge 102c of blade 102 by between approximately 5″ to 18″. In some embodiments, the blade 102 may be designed for a smaller digging tool and the cut-out length L_{C} may be between approximately 1″ to 7″, the lower body length L_{LB} may be between approximately 3″ to 10″. In certain embodiments, the blade 102 may be designed for a large digging machine or device and the cut-out length L_{C} may be between approximately 6″ to 40″ or more, the lower body length L_{LB} may be between approximately 12″ to 50″ or more.

Moreover, the opening 108 may include a cut-out width W_{C} extending across the blade 102 by between approximately 2″ to 22″. Further, the lower body 110a may include a width W_{LB} extending from the upper edge 102c of blade 102 by between approximately 5″ to 32″. In some embodiments, the blade 102 may be designed for a smaller digging tool and the cut-out width W_{C} may be between approximately 2″ to 12″, the lower body width W_{LB} may be between approximately 3″ to 18″. In certain embodiments, the blade 102 may be designed for a large digging machine or device and the cut-out width W_{C} may be between approximately 6″ to 40″ or more, the lower body width W_{LB} may be between approximately 12″ to 50″ or more.

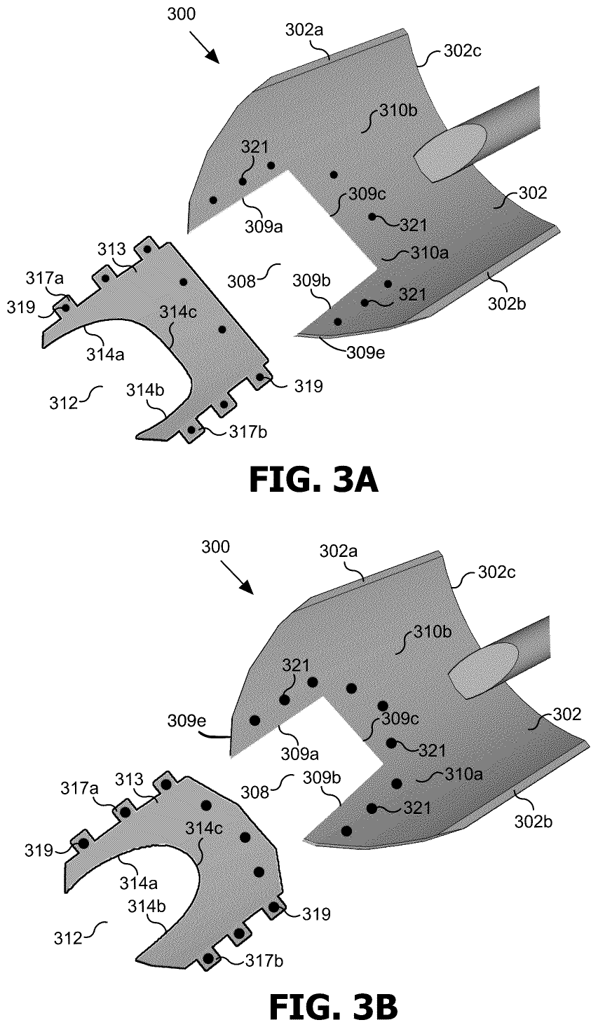

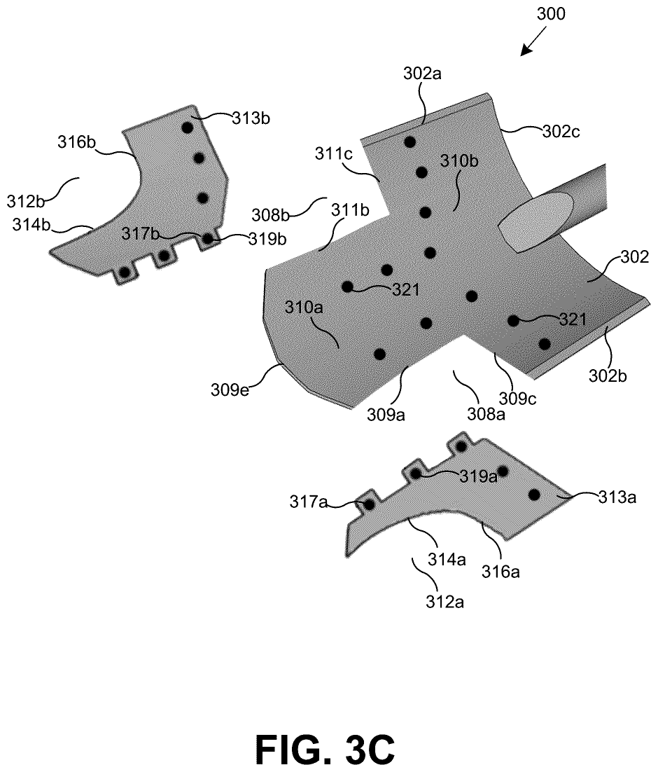

In some embodiments, as shown in FIGS. 1A-1B, the example blade 102 opening 108 may include one or more guards or paddings 113a, 113b, for example one or more padding 113a segments on the right side of opening 108 and one or more padding 113b segments on the left side of opening 108. In certain embodiments, the paddings 113a, 113b may be one unity piece extending and covering across the upper boundary 109c and side boundaries 109a, 109b of opening 108. Moreover, the example blade 102 may be configured or formed using any elliptical shape (i.e., any elliptical shaped cut-out), some elliptical shapes are shown, for example, in FIGS. 1A, 1G-1H, and 3B-3C. The elliptical shape for the blade 102 may formed using any cut-out length, L_{C}, and any cut-out width W_{C}. In certain embodiments, the elliptical shape may be positioned centrally on the blade to extend horizontally across the blade between side boundaries 109a, 109b. In certain embodiments, the elliptical shape may be positioned centrally on the blade to extend vertically across the blade between the lower edge 109e (lower edge of blade). Furthermore, the one or more openings 108 (i.e., the cut-out) and one or more guards or paddings 113a, 113b are not limited to being elliptical in shape and may be configured to be parabolic, square, rectangular, circular, or any polygonal shape.

In some embodiments, the one or more guards or paddings 113a, 113b may be fixed, welded, bolted down, or otherwise permanently formed on the example blade 102. In certain embodiments, the one or more guards or paddings 113a, 113b may be detachable mounted, screwed into, or otherwise detachably formed on the example blade 102 using corresponding attachment points 115a, 115b. In many embodiments, at least one of the one or more openings 108 (i.e., the cut-out), one or more guards or paddings 113a, 113b, and the one or more attachment points 115a, 115b may be formed anywhere on the blade 102, for example, on or between the lower body 110a, the upper body 110b, the right side edge 102a, the left side edge 102b, the upper edge 102c, and the lower edge 109e (lower edge of blade). Moreover, the one or more guards or paddings 113a, 113b and attachment points 115a, 115b may be made of various materials, not limited to, for example, metals, metal alloys, plastics, wood, rubber (e.g., any natural or synthetic elastomers, fillers (e.g. carbon black, precipitated silica or silicates) and additives, polymers, etc.,), polycarbonate materials, polypropylene, polyethylene terephthalate (PET), polyethylene terephthalate glycol (PETG), acrylonitrile butadiene styrene (ABS), nylon, resins, graphite, and carbon fiber and the like.

In FIG. 1A, an example digging tool 100 may include an interface A configured to divide an upper body 110b from a lower body 110a, and an opening 108 configured to be formed below the interface A. The opening 108 may be parabolic or elliptical in shape and may further extend into the lower body 110a by a cut-out length L_{C}. In some embodiments, the lower edge 109e (lower edge of blade 102) of the lower body 110a may be flat or straight to prevent damage to: a blade 102, one or more other obstructions, or obstacles adjacent to an obstruction. For example, to prevent damage to the digging tool 100 and a utility line or pipe extending vertically up from the soil and adjacent to a physical boundary, for example, a sprinkler head or piping adjacent to an edge of a paved or cement walkway. In many embodiments, the opening 108 may include side boundaries 109a, 109b configured to have one or more linear or straight portions extending into lower body 110a. For example, one or more portions of side boundaries 109a, 109b may extend at the same or similar angle into the lower body 110a and gradually curve into the upper boundary 109c. For example, one or more portions of side boundaries 109a, 109b may be configured to extend between 0 to 45 degrees away from the upper boundary 109c and gradually curve into a straight or linear surface extending perpendicular to the upper boundary 109c. In some embodiments, the upper boundary 109c may be curved or flat to provide adequate clearance to prevent damage to an obstruction.

In FIG. 1B, an example digging tool 100 may include an interface A configured to divide an upper body 110b from a lower body 110a, and an opening 108 configured to be formed below the interface A. The opening 108 may be configured to be U-shaped and may further extend across the lower body 110a by a cut-out width W_{C}. The lower body 110a may extend across the blade 102 below the interface A by a lower body width W_{LB}. In some embodiments, the lower edge 109e of the lower body 110a may be flat or straight to prevent damage to the blade 102 to one or more other obstructions or obstacles adjacent to an obstruction. In certain embodiments, the lower edge 109e of the lower body 110a may be tapered, jagged, or sharp to provide a piercing, cutting, or digging function. The cut-out width W_{C} and lower body width W_{LB} may be configured as needed to provide adequate clearance to prevent damage to the blade 102 and one or more surface level or buried obstructions or obstacles. In many embodiments, the opening 108 may include side boundaries 109a, 109b configured to have one or more contour or curved portions extending into lower body 110a. In certain embodiments, one or more portions of side boundaries 109a, 109b may extend at the same or similar angle into the lower body 110a and gradually curve into the upper boundary 109c. In some embodiments, the upper boundary 109c may be slightly curved or flat to provide adequate clearance to prevent damage to an obstruction or to prevent the blade 102 from being damaged by striking the obstruction. In many embodiments, the opening 108 may be configured to gradually decrease towards the upper boundary 109c to provide adequate clearance for an obstruction. In certain embodiments, the opening 108 may be configured to gradually decrease towards the upper boundary 109c to provide clearance for the obstruction and provide better removal of soil, debris, or other material surrounding the obstruction.

In FIG. 1C, an example digging tool 100 may include an opening 108 configured to have one or more portions along an upper boundary 109c that protrude away from a lower body 110a of an example blade 102. In some embodiments, the upper boundary 109c may include an interstitial region 109d between lower body 110a and upper body 110b. In some embodiments, the surface of the interstitial region 109d and the upper boundary 109c may both be configured to have an incline (e.g., an inclined surface or a funnel surface) with respect to the surface of lower body 110a to avoid having a blunt edge directly striking a surface level or buried obstruction or obstacle. In certain embodiments, the interstitial region 109d may include a dimpled surface. In some embodiments, at least one of the interstitial region 109d, the lower body 110a, and upper body 110b may include a dimpled surface, or one or more portions having a dimpled surface to reduce friction between the soil and the blade 102 in the process of, for example, digging or piercing. In many embodiments, one or more portions of the surface of the interstitial region 109d and lower body 110a may be similar or the same, and the upper boundary 109c may protrude as an arc between the side boundaries 109a, 109b to avoid having a blunt edge directly striking a surface level or buried obstruction or obstacle. The opening 108 may be configured to gradually increase or decrease towards the upper boundary 109c to provide adequate clearance for an obstruction. In certain embodiments, the opening 108 may be configured to neither increase or decrease towards the upper boundary 109c to provide clearance for the obstruction and provide better removal of soil, debris, or other material surrounding the obstruction.

In FIG. 1D, an example digging tool 100 may include an opening 108 positioned on and cutting into at least one side of a lower body 110a of blade 102, the opening 108 may further extend into the lower body 110a to an interface A. In some embodiments, one or more portions on the lower body 110a adjacent to the opening 108 may be tapered, jagged, or sharp to provide a cutting or piercing function for the digging tool 100. In many embodiments, the length L_{C} and width W_{C} of the opening 108 may be extended further into the interface A to provide adequate protection for the surfaces of the blade 102 and protection from striking or damaging surface level or buried obstacles and obstructions. In some embodiments, the opening 108 may be position at an angle on the lower body 110a. In certain embodiments, the opening 108 may be positioned on a left portion of the lower body 110a. Moreover, the example digging tool 100 may be divided into a plurality of distinct functions, for example, the distal lower right portion of the lower body 110a may provide a cutting or piercing function, the central portion of the lower body 110a may include one or more openings 108 to protect from damaging the blade 102 and obstacle/obstruction, and the distal lower left portion of the lower body 110a may provide a digging, scooping, or holding function. By way of illustration, it follows that the position, shape, and dimensions of the opening 108, the lower body 110a, and upper body 110b may be configured as desired to provide a blade for an appropriate tool, device, or machine that provides one or more particular functions as described herein the present disclosure. Further, it can be appreciated that the blade 102 may be designed based on the present disclosure to fit more than one tool, device, or machine to provide better performance, and safer handling and/or digging capabilities.

In FIG. 1E, an example digging tool 100 may have a plurality of openings (i.e., cut-outs) 108a, 108b . . . 108n. In some embodiments, a blade 102 of the digging tool 100 may include opening 108a and opening 108b having side boundary 109a and upper boundary 109c and side boundary 111b and upper boundary 111c, respectively. In many embodiments, each opening 108a, 108b . . . 108n may be formed in at least one of a lower body 110a or an upper body 110b of the blade 102. Moreover, each opening 108a, 108b . . . 108n may include at least one side boundary 109a and at least one upper boundary 109c. In certain embodiments, each opening 108a, 108b . . . 108n may be formed in at least one of a right side edge 102a, left side edge 102b, or upper edge 102c of the blade 102. In certain embodiments, the openings 108a, 108b . . . 108n, for example, openings 108a, 108b may be formed at the left side edge 102b and right side edge 102a, respectively, to provide protection from damage to the blade 102 and one or more surface level or buried obstructions or obstacles. As described in the present disclosure, at least one or more portions of the side boundaries 109a, 111b and upper boundaries 109c, 111c may be configured to have a linear, curved, piecewise linear, or piecewise curved shape or edge.

In FIG. 1F, an example digging tool 100 may have one or more openings 108 formed along a left side edge 102b of a blade 102 cutting into interface A and lower body 110a and extending into upper body 110b of the blade 102. In some embodiments, the one or more openings 108 may be formed on either a right side edge 102a or the left side edge 102b of a shovel 102. 108b . . . 108n. In FIG. 1G, an example digging tool 100 may have one or more elongated openings 108 cutting into the lower body 110a of the blade 102 and extending into interface A and an upper body 110b of the blade 102. In some embodiments, the elongated opening 108 may facilitate better protection from damaging or piercing/cutting into a surface level or buried obstruction or obstacle within the elongated opening 108. In FIG. 1H, an example digging tool 100 may have one or more tapered openings 108 tapered or pinched at a lower edge 109e of a blade 102. The one or more tapered openings 108 may cut into the lower body 110a of the blade 102 and extend into interface A and an upper body 110b of the blade 102. In some embodiments, the tapered opening 108 may facilitate better soil removal or piercing/cutting function for blade 102 while still allowing clearance for a surface level or buried obstruction or obstacle within the tapered opening 108.

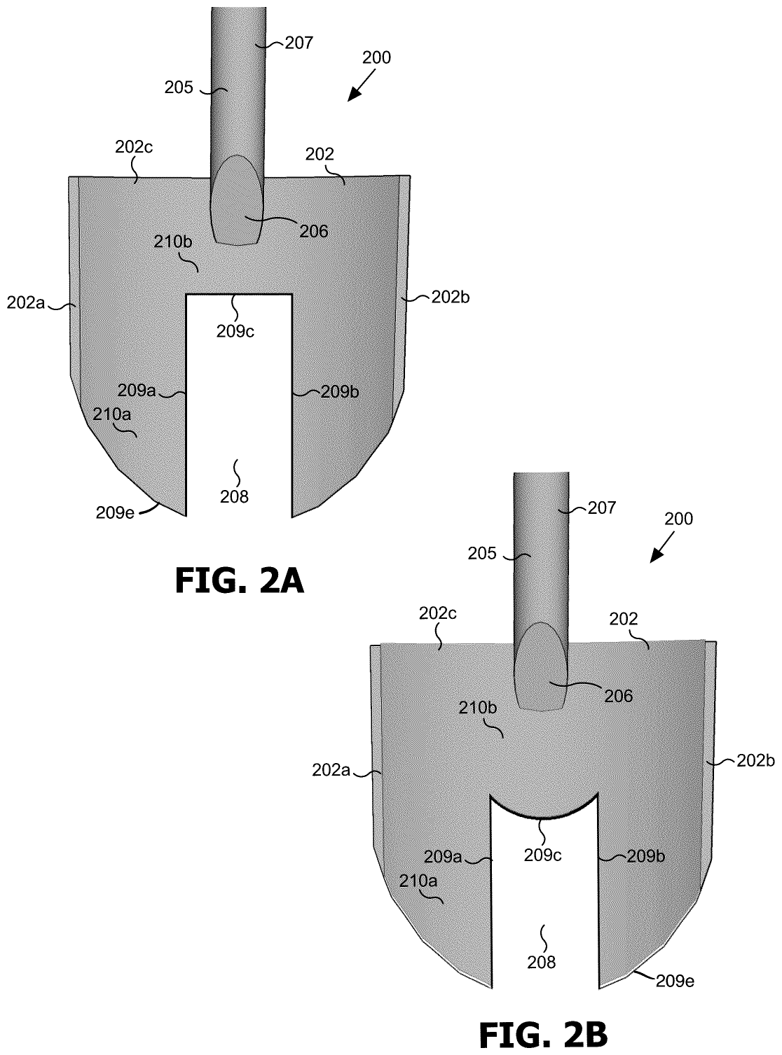

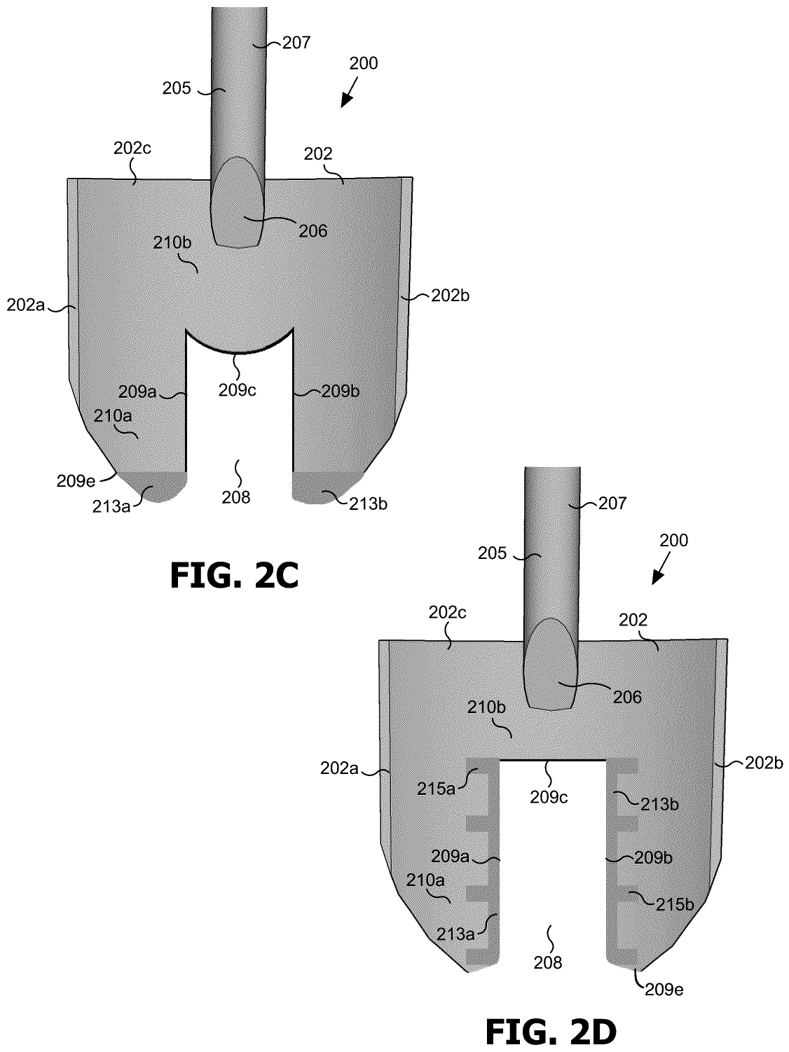

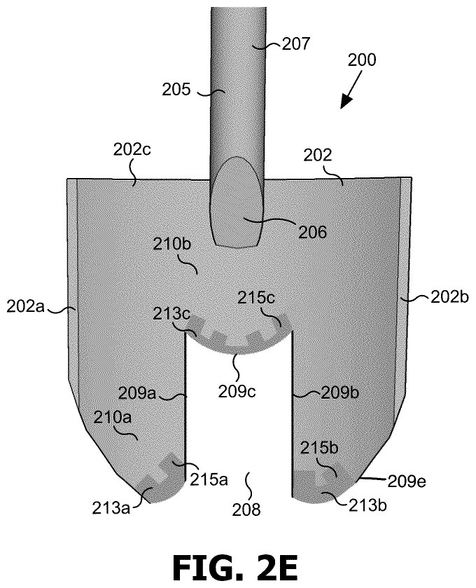

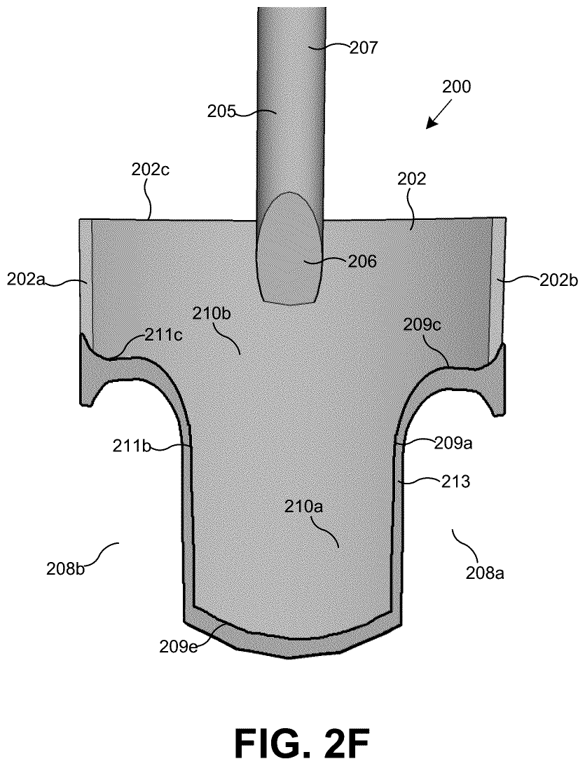

FIGS. 2A-2F illustrates a front view of an example blade for digging, unearthing, or excavation in accordance with one or more embodiments of the present disclosure. As shown in FIGS. 2A-2F, the blade fitting 200 may include a cylinder 205 coupling a blade 202 to a tool, machine, or handle. The cylinder 205 may include a lower surface 206 adjacent to a first end and an upper surface 207 adjacent to a second end. The blade 202 may include a lower body 210a, an upper body 210b, right side edge 202a, left side edge 202b, and an upper edge 202c. In many embodiments, on the blade 202 may be formed at least one notch or opening 208 having boundaries defined by at least one of: a lower body 210a, an upper body 210b, right side edge 202a, left side edge 202b, and an upper edge 202c. One or more openings 208 may include an upper boundary 209c/211, and at least one side boundary 209a, 209b, 211b. Further, the one or more openings 208 may include at least one of a square, rectangular, parabolic, elliptical, or circular shape. In many embodiments, the blade 202 may further include one or more contoured surfaces formed on at least on one of: a lower body 210a, an upper body 210b, along the right side edge 202a, along the left side edge 202b, and along an upper edge 202c.

In some embodiments, the cylinder 205 may be a hollow cylinder or rod configured to receive, fit on, or attach to at least one of a tool, a handle, or a machine. In some embodiments, the blade 202 may attach directly to a handle, a machine, or other tool. Although a blade 202 in the present disclosure is described in certain embodiments as being attached to a tool, or forming a digging tool, it is by way of example and not by limitation, and as such, a blade 202 can also be formed for, and/or attached to, any other tool (e.g., trowel, saw, etc.,) or machine (e.g., bulldozer, snow plow, thatcher tool, etc.,). Thus, disclosure for the embodiments described in the present invention for a blade may be instantly applied to any other blade for another tool or a machine as desired. Further, it follows that the position, shape, and dimensions of the cylinder 205 may be configured as desired to provide a fixable, detachable, or mountable blade 202 for an appropriate tool, device, or machine that provides one or more particular functions as described herein the present disclosure.

The one or more openings 208 may each include one or more side boundaries 209a, 209b, 211b and upper boundaries 209c/211c. In many embodiments, at least one of the side boundaries 209a, 209b, 211b and upper boundaries 209c/211c may be configured to have a linear, curved, piecewise linear, or piecewise curved shape or edge. In some embodiments, the one or more openings 208 may be configured to have parallel side boundaries 209a, 209b, 211b. Moreover, the example blade 202 may be divided into a plurality of distinct regions and/or functions, for example, the distal lower right portion of the lower body 210a may provide a cutting or piercing function, the central portion of the lower body 210a may include one or more openings 208 to protect from damaging the blade 202 and obstacle/obstruction, and the distal lower left portion of the lower body 210a may provide a digging, scooping, or holding function. Further, it follows that the position, shape, and dimensions of the opening 208, the lower body 210a, and upper body 210b may be configured as desired to provide a blade for an appropriate tool, device, or machine that provides one or more particular functions as described herein the present disclosure.

In FIG. 2A, an example blade 202 may include an opening 208 cutting into an upper body 210b from a lower body 210a, the opening 208 may be configured to be centered on the blade 202 and formed below a lower surface 206 of a cylinder 205. The opening 208 may be square or rectangular in shape and may further extend into one or more surfaces or areas of the upper body 210b. In some embodiments, the lower edge 209e (lower edge of blade 202) of the lower body 210a may be flat or straight to prevent damage to: the blade 202, one or more other obstructions, or obstacles adjacent to an obstruction. In many embodiments, the opening 208 may include side boundaries 209a, 209b configured to have one or more linear or straight portions extending from lower body 210a into upper body 210b. In some embodiments, the upper boundary 209c may be curved or flat to provide adequate clearance to prevent damage to an obstruction.

In FIG. 2B, an example blade 202 may include an opening 208 cutting into a lower body 210a and an upper body 210b, the opening 208 may be configured to be off-centered on the blade 202 and formed below a lower surface 206 of a cylinder 205. The opening 208 may be square or rectangular in shape and may further extend into one or more surfaces or areas of the upper body 210b. In many embodiments, one or more portions of the upper boundary 209c may be curved to prevent a blunt or sharp edge striking and/or damaging the blade 202, one or more other obstructions, or obstacles adjacent to an obstruction. In certain embodiments, the upper boundary 209c may form an arc and connect between the side boundaries 209a, 209b. In some embodiments, the side boundaries 209a, 209b may be slightly curved or extend diagonally inwards or outwards from the ends of the upper boundary 209c to provide adequate clearance to prevent damage to an obstruction.

In FIG. 2C, an example blade 202 may include an opening 208 cutting into an upper body 210b from a lower body 210a, the opening 208 may be configured to be centered on the blade 202 and formed below a lower surface 206 of a cylinder 205. The opening 208 may be square or rectangular in shape and may further extend into one or more surfaces or areas of the upper body 210b. In many embodiments, the opening 208 may include side boundaries 209a, 209b configured to have one or more linear or straight portions extending from lower body 210a into upper body 210b. In some embodiments, the upper boundary 209c may be curved or flat to provide adequate clearance to prevent damage to an obstruction. The side boundaries 209a, 209b may each be configured with one or more paddings 213a, 213b. The paddings 213a, 213b may provide a guard or protection from damage to the lower edges 209e of the blade 202 and surface level or buried obstructions or obstacles. In some embodiments, the paddings 213a, 213b may be fixed or permanently formed on the lower edge 209e of the blade 202. In certain embodiments, various shaped and sized paddings 213a, 213b may be used as desired. Moreover, the paddings 213a, 213b may detachably couple to the lower edge 209e of the blade 202 by any one of: screws, pins, bolts, hooks, or the like.

In FIG. 2D, an example blade 202 may include a plurality of side boundaries 209a, 209b each configured to receive one padding 213a, 213b. Each padding 213a, 213b may be fixed or permanently formed on the lower edge 209e of the blade 202 using a plurality of attachment points 215a, 215b, respectively. The plurality of attachment points 215a, 215b may be, for example, weld points that fix each portion of padding 213a, 213b to each of the plurality of attachment points 215a, 215b. In certain embodiments, the plurality of attachment points 215a, 215b may be configured to detachably couple each padding 213a, 213b to the side boundaries 209a, 209b of the blade 202 by any one of: bolts, screws, pins, nuts, or the like. For example, the attachment points 215a, 215b may include notches, holes, or cavities formed in the blade 202 that align with similar sized and positioned holes or notches on each padding 213a, 213b. Then bolts, screws, pins, nuts, or the like may be used to fix each padding 213a, 213b to the blade 202 at each attachment point 215a, 215b. Similarly, in FIG. 2E, each side boundary 209a, 209b and upper boundary 209c on the blade 202 may include attachment points 215a, 215b, 215c . . . 215n to receive and secure each padding 213a, 213b, 213c . . . 213n, respectively to the blade 202. In many embodiments, one or more paddings 213a, 213b, 213c . . . 213n may be configured to cover the blade 202 to protect the blade 202, the buried/surface level obstruction, or both. One or more padding 213a, 213b, 213c . . . 213n segments may be added, attached, formed, or permanently fixed to the blade 202 to protect the desired blade 202 surface and the buried/surface level obstruction.

In FIG. 2F, an example blade 202 may include a plurality of openings (i.e., cut-outs) 208a, 208b . . . 208n, each opening 208a, 208b having a side boundary 209a, 211b and upper boundary 209c, 211c, respectively. In some embodiments, each side boundary 209a, 211b may be configured to receive a padding 213. In some embodiments, the padding 213 may cover the piercing/cutting portion of the right and left side edges 202a, 202b. The padding 213 may include and semi-hard or semi-rigid and durable material, for example, rubber, hard plastic, or the like. As described in the present disclosure, the padding 213 may be fixed or permanently formed along the lower edge 209c, side boundary 209a, 211b and upper boundary 209c, 211c of the blade 202. In some embodiments, the padding 213 may include one or more portions that fit or secure onto the blade 202. In certain embodiments, various shaped and sized padding 213 may be used as desired to provide additional buffer or guard in digging, shoveling, or excavation. In many embodiments, one or more paddings 213 may be configured to cover the blade 202 to protect the blade 202 or cover a piercing function (or other function) of the blade 202, to prevent damage to the functioning part(s) of the blade 202, the buried/surface level obstruction, or both. One or more padding 213 segments may be added, attached, formed, or permanently fixed to the blade 202 to protect the desired blade 202 surface and the buried/surface level obstruction.

FIGS. 3A-3C illustrate a front perspective view of an example blade with an example protective guard in accordance with one or more embodiments of the present disclosure. As shown in FIGS. 3A-3C, the blade fitting 300 may include a blade 302 that may be removably attached to or permanently fixed to a tool, machine, or handle. The blade 302 may include a lower body 310a, an upper body 310b, right side edge 302a, left side edge 302b, and an upper edge 302c. In many embodiments, on the blade 302 may be formed at least one notch or opening 308a, 308b . . . 308n having boundaries defined by at least one of: a lower body 310a, an upper body 310b, right side edge 302a, left side edge 302b, and an upper edge 302c. One or more openings 308a, 308b . . . 308n may include corresponding upper boundaries 309c. 311c and side boundaries 309a, 311b. Further, the one or more openings 308a, 308b . . . 308n may include at least one of a square, rectangular, parabolic, elliptical, or circular shape. In many embodiments, the blade 302 may further include one or more contoured surfaces formed on at least on one of: a lower body 310a, an upper body 310b, along the right side edge 302a, along the left side edge 302b, and along an upper edge 302c.

The blade 302 may include a plurality of attachment points 321 that may couple and/or fix protection guard 313 to the blade 302. The protection guard 313 may include a top surface 314c and side surfaces 314a, 314b that define one or more guard openings 312. The protection guard 313 may further include corresponding plurality of brackets 317a, 317b each bracket may be configured to have a mounting point 319 corresponding to the each of the plurality of attachment points 321. The brackets 317a, 317b may secure the protection guard 313 to the blade 302 by fixing each of the plurality of attachment points 321 to each of the plurality of mounting points 319. In certain embodiments, the plurality of attachment points 321 may be configured to detachably couple or secure to each of the plurality of mounting points 321 of the blade 302 by using any one of: bolts, screws, pins, nuts, or the like. Further, the protection guard 313 may include and semi-hard or semi-rigid and durable material, for example, rubber, hard plastic, or the like. The protection guard 313 may provide one or more guard openings 312 with at least one of a different size, shape, or dimension than the opening 308 of the blade 302. In this way, the opening 308 of the blade 302 may be altered and different portions of the blade 302 can serve different functions as described in the present disclosure. For example, the protection guard 313 may include a sharpened tip at each side to provide better piercing or cutting function. In FIG. 3B, the protection guard 313 may include one or more elliptical guard openings 313.

Further, as shown in FIG. 3C, the blade 302 may include a plurality of openings 308a, 308b . . . 308n, each being bounded by a corresponding side boundary 309a, 311b and upper boundary 309c, 311c. Similarly, each of a plurality of protection guards 313a, 313b . . . 313n may attach to the blade 302 at a corresponding opening 308a, 308b . . . 308n. In some embodiments, each of the plurality of protection guards 313a, 313b . . . 313n may provide an opening 312a, 312b . . . 312n having at least one of a different size, shape, or dimension than the opening 308a, 308b . . . 308n of the blade 302. Each protection guard opening 312a, 312b . . . 312n may be configured to be bound by one or more side boundaries 314a, 314b . . . 314n and upper boundary 316a, 316b . . . 316n.

In many embodiments, blade openings 308a, 308b . . . 308n and protection guard openings 312a, 312b . . . 312n may be configured to have a linear, curved, piecewise linear, or piecewise curved shape or edge. Moreover, the blade openings 308a, 308b . . . 308n and corresponding protection guards 313a, 313b . . . 313n may be used together to divide the blade 302 into a plurality of distinct regions and/or functions, for example, the distal lower right portion of the lower body 310a may provide a cutting or piercing function, the central portion of the lower body 310a may include one or more openings 308a, 308b . . . 308n to protect from damaging the blade 302 and obstacle/obstruction, and the distal lower left portion of the lower body 310a may provide a digging, scooping, or holding function.

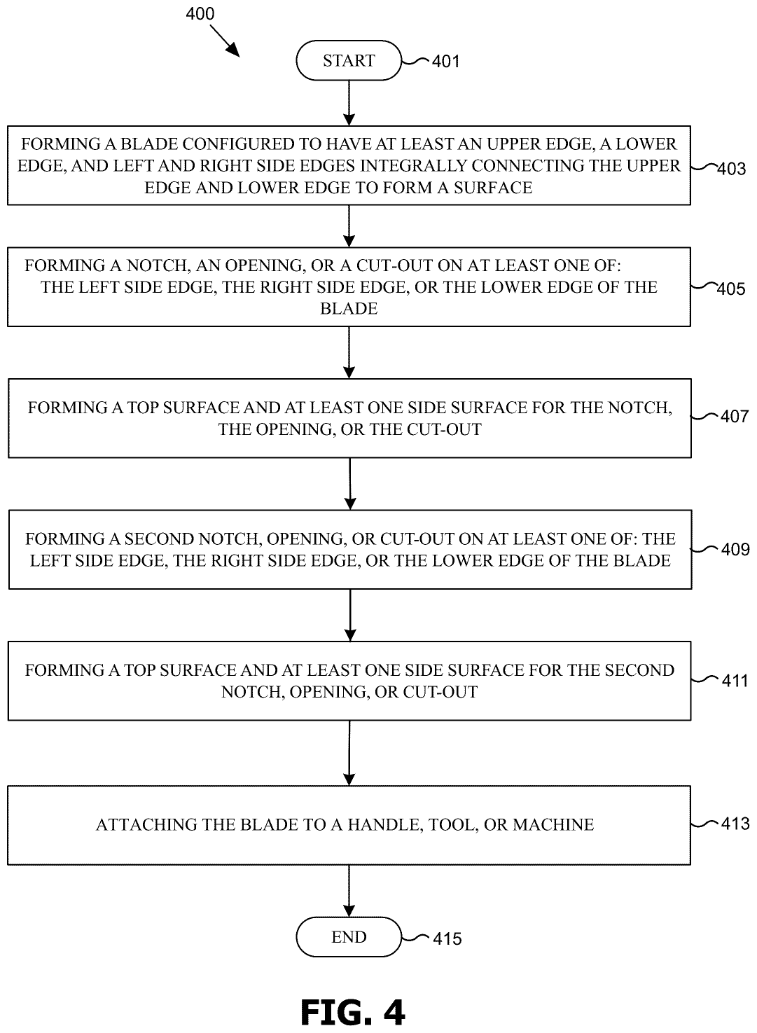

FIG. 4 illustrates an example flow chart showing a method of making an example blade for digging, shoveling, or excavation in accordance with one or more embodiments of the present disclosure. These exemplary methods are provided by way of example, as there are a variety of ways to carry out these methods. Each block shown in FIG. 4 represents one or more processes, methods or subroutines, carried out in the exemplary method. FIGS. 1A-3C show example embodiments of carrying out the method of FIG. 4 for, for example, preventing damage to a blade or digging tool, one or more buried obstructions and obstacles, one or more surface level obstructions and obstacles, piping, plumbing, or utility lines. Each block shown in FIG. 4 represents one or more processes, methods or subroutines, carried out in the exemplary method. The exemplary method may begin at block 401. Method 400 may be used independently or in combination with other methods or process for preventing damage to a blade or digging tool, one or more buried obstructions and obstacles, one or more surface level obstructions and obstacles, piping, plumbing, or utility lines. For explanatory purposes, the example process 400 is described herein with reference to the digging tools and blades of FIGS. 1A-3C. Further for explanatory purposes, the blocks of the example process 400 are described herein as occurring in serial, or linearly. However, multiple blocks of the example process 400 may occur in parallel. In addition, the blocks of the example process 400 may be performed in a different order than the order shown and/or one or more of the blocks of the example process 400 may not be performed. Further, any or all blocks of example process 400 may further be combined and done in parallel, in order, or out of order.

In FIG. 4, the exemplary method 400 of preventing damage to a blade or digging tool, one or more buried obstructions and obstacles, one or more surface level obstructions and obstacles, piping, plumbing, or utility lines is shown. Method 400 begins at block 401. In block 403, the method includes forming a blade configured to have at least an upper edge, a lower edge, and left and right side edges integrally connecting the upper edge and lower edge to form a surface.

In block 405, the method includes forming a notch, an opening, or a cut-out on at least one of: the left side edge, the right side edge, or the lower edge of the blade. In some embodiments, a plurality of notches, openings, or cut-outs may be formed on the blade. In certain embodiments, the notch, opening, or cut-out may be formed at the left or right side edge of the blade thereby having only one side boundary.

In block 407, the method includes forming a top surface and at least one side surface for the notch, the opening, or the cut-out. In block 409, the method includes forming a second notch, opening, or cut-out on at least one of: the left side edge, the right side edge, or the lower edge of the blade. In block 411, the method includes forming a top surface and at least one side surface for the second notch, the opening, or the cut-out. In block 413, the method includes attaching the blade to a handle, tool, or machine. The method ending in block 415.

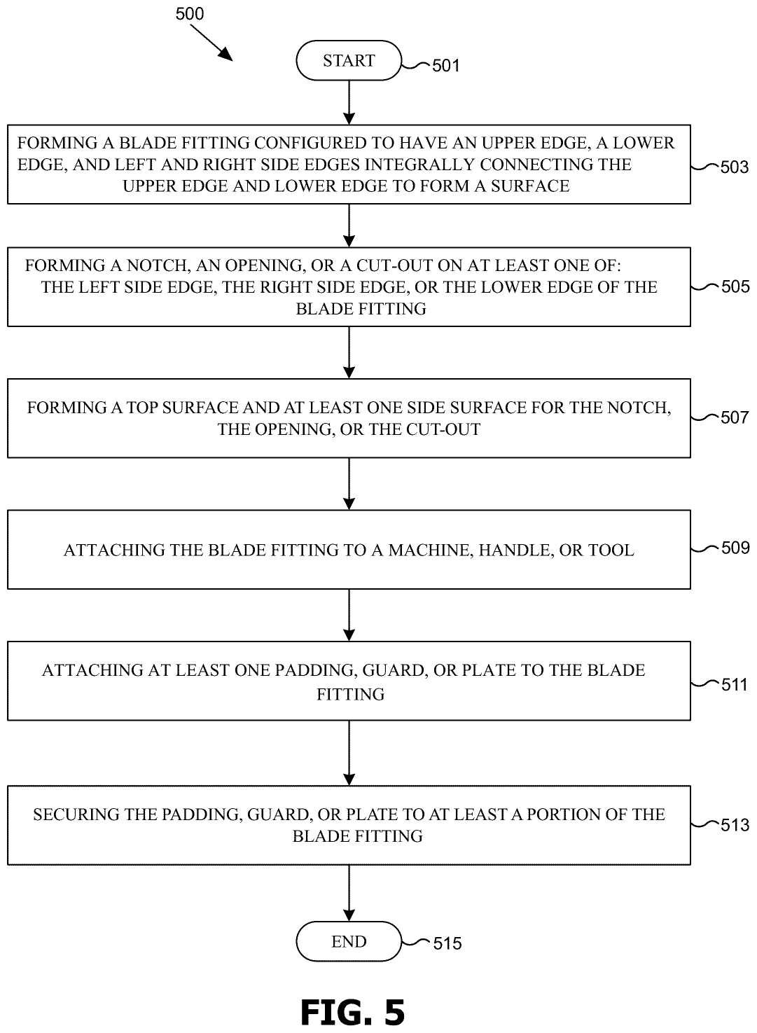

FIG. 5 illustrates an example flow chart showing a method of making an example blade fitting having a blade for digging, shoveling, or excavation in accordance with one or more embodiments of the present disclosure. These exemplary methods are provided by way of example, as there are a variety of ways to carry out these methods. Each block shown in FIG. 5 represents one or more processes, methods or subroutines, carried out in the exemplary method. FIGS. 1A-3C show example embodiments of carrying out the method of FIG. 5 for, for example, preventing damage to a blade or digging tool, one or more buried obstructions and obstacles, one or more surface level obstructions and obstacles, piping, plumbing, or utility lines. Each block shown in FIG. 5 represents one or more processes, methods or subroutines, carried out in the exemplary method. The exemplary method may begin at block 501. Method 500 may be used independently or in combination with other methods or process for preventing damage to a blade or digging tool, one or more buried obstructions and obstacles, one or more surface level obstructions and obstacles, piping, plumbing, or utility lines. For explanatory purposes, the example process 500 is described herein with reference to the digging tools and blades of FIGS. 1A-3C. Further for explanatory purposes, the blocks of the example process 500 are described herein as occurring in serial, or linearly. However, multiple blocks of the example process 500 may occur in parallel. In addition, the blocks of the example process 500 may be performed in a different order than the order shown and/or one or more of the blocks of the example process 500 may not be performed. Further, any or all blocks of example process 500 may further be combined and done in parallel, in order, or out of order.

In FIG. 5, the exemplary method 500 of preventing damage to a blade or digging tool, one or more buried obstructions and obstacles, one or more surface level obstructions and obstacles, piping, plumbing, or utility lines is shown. Method 500 begins at block 501. In block 503, the method includes forming a blade fitting configured to have an upper edge, a lower edge, and left and right side edges integrally connecting the upper edge and lower edge to form a surface. The surface of the blade fitting including a blade.

In block 505, the method includes forming a notch, an opening, or a cut-out on at least one of: the left side edge, the right side edge, or the lower edge of the blade fitting. In some embodiments, a plurality of notches, openings, or cut-outs may be formed on the blade fitting. In certain embodiments, the notch, opening, or cut-out may be formed at the left or right side edge of the blade fitting thereby having only one side boundary.

In block 507, the method includes forming a top surface and at least one side surface for the notch, the opening, or the cut-out. In block 509, the method includes attaching the blade fitting to a machine, handle, or tool. In block 511, the method includes attaching at least one padding, guard, or plate to the blade fitting. In block 513, the method includes securing the padding, guard, or plate to at least a portion of the blade fitting to protect against damage to the blade and one or more buried or surface level obstacles or obstructions. The method ending in block 515.

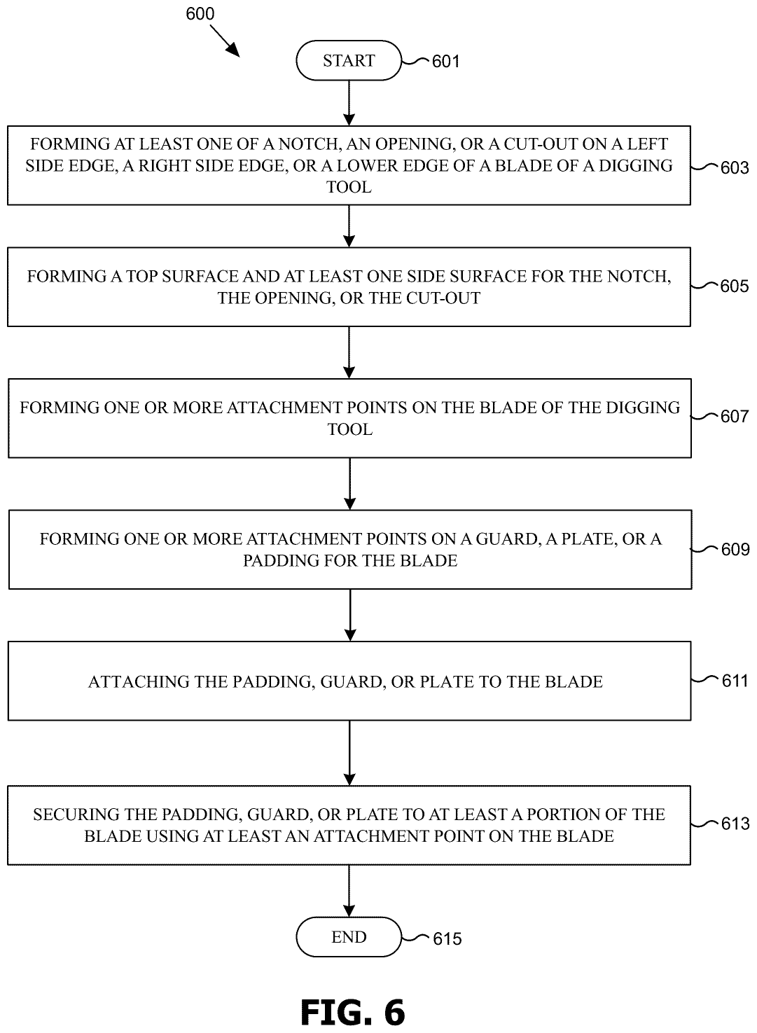

FIG. 6 illustrates an example flow chart showing a method of making an example digging tool in accordance with one or more embodiments of the present disclosure. These exemplary methods are provided by way of example, as there are a variety of ways to carry out these methods. Each block shown in FIG. 6 represents one or more processes, methods or subroutines, carried out in the exemplary method. FIGS. 1A-3C show example embodiments of carrying out the method of FIG. 6 for, for example, preventing damage to a blade or digging tool, one or more buried obstructions and obstacles, one or more surface level obstructions and obstacles, piping, plumbing, or utility lines. Each block shown in FIG. 6 represents one or more processes, methods or subroutines, carried out in the exemplary method. The exemplary method may begin at block 601. Method 600 may be used independently or in combination with other methods or process for preventing damage to a blade or digging tool, one or more buried obstructions and obstacles, one or more surface level obstructions and obstacles, piping, plumbing, or utility lines. For explanatory purposes, the example process 600 is described herein with reference to the digging tools and blades of FIGS. 1A-3C. Further for explanatory purposes, the blocks of the example process 600 are described herein as occurring in serial, or linearly. However, multiple blocks of the example process 600 may occur in parallel. In addition, the blocks of the example process 600 may be performed in a different order than the order shown and/or one or more of the blocks of the example process 600 may not be performed. Further, any or all blocks of example process 600 may further be combined and done in parallel, in order, or out of order.

In FIG. 6, the exemplary method 600 of preventing damage to a blade or digging tool, one or more buried obstructions and obstacles, one or more surface level obstructions and obstacles, piping, plumbing, or utility lines is shown. Method 600 begins at block 601. In block 603, the method includes forming at least one of a notch, an opening, or a cut-out on a left side edge, a right side edge, or a lower edge of a blade of a digging tool. In some embodiments, a plurality of notches, openings, or cut-outs may be formed on the blade fitting. In certain embodiments, the notch, opening, or cut-out may be formed at the left or right side edge of the blade fitting thereby having only one side boundary.

In block 605, the method includes forming a top surface and at least one side surface for the notch, the opening, or the cut-out. In block 607, the method includes forming one or more attachment points on the blade of the digging tool. In block 609, the method includes forming one or more attachment points on a guard, a plate, or a padding for the blade. In block 611, the method includes attaching the padding, guard, or plate to the blade. In block 613, the method includes securing the padding, guard, or plate to at least a portion of the blade fitting to protect against damage to the blade and one or more buried or surface level obstacles or obstructions. The method ending in block 615.

The term “within a proximity”, “a vicinity”, “within a vicinity”, “within a predetermined distance”, “predetermined width”, “predetermined height”, “predetermined length” and the like may be defined between about 0.1 meter and about 3.5 meters. The term “coupled” is defined as connected, whether directly or indirectly through intervening components, and is not necessarily limited to physical connections. The connection may be such that the objects are permanently connected or releasably connected. The term “substantially” is defined to be essentially conforming to the particular dimension, shape, or other feature that the term modifies, such that the component need not be exact. For example, “substantially cylindrical” means that the object resembles a cylinder, but may have one or more deviations from a true cylinder. The term “comprising,” when utilized, means “including, but not necessarily limited to”; it specifically indicates open-ended inclusion or membership in the so-described combination, group, series and the like.

The term “a predefined” or “a predetermined” when referring to length, width, height, or distances may be defined as between about 0.1 meter and about 3.5 meters.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the present disclosure, the disclosure, the present disclosure, other variations thereof and alike are for convenience and do not imply that a disclosure relating to such phrase(s) is essential to the present disclosure or that such disclosure applies to all configurations of the present disclosure. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description of the disclosed embodiments is provided to enable a person skilled in the art to make or use the disclosed embodiments. Various modifications to these embodiments will be readily apparent to those skilled in the art, and the principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

The embodiments shown and described above are only examples. Many details are often found in the art such as the other features of an image device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A digging tool, comprising:
a blade having a lower edge, an upper edge configured to attach to at least one of a handle, a machine, or other tool, and left and right side edges integrally connecting the lower edge and the upper edge to form a surface;
a notch formed on at least one of: a left side edge, a right side edge, or the lower edge of the blade, the notch being configured to have a top surface and at least one side surface, the notch extending inwards from a peripheral edge of the surface of the blade.

2. The digging tool of claim 1, wherein an openness of the notch distal to the upper edge of the blade is configured to gradually decrease to the openness of the top surface proximal to the upper edge.

3. The digging tool of claim 1, wherein the notch is configured to have at least one of: a parabolic shape, a rectangular shape, a piecewise rectilinear shape, or a piecewise curvilinear shape.

4. The digging tool of claim 3, wherein the top surface of the notch is concave and projects away from the upper edge of the blade.

5. The digging tool of claim 1, wherein the blade attaches to a handle, and the handle is configured to be fixed to at least the upper edge of the blade.

6. The digging tool of claim 1, wherein an openness of the notch at one end is configured to be equal to or greater than the openness of the notch at an opposite end.

7. The digging tool of claim 1, wherein the notch is a leaf shaped cut-out.

8. The digging tool of claim 1, wherein the notch is a spade-shaped cut-out.

9. A shovel blade, comprising:
an upper edge, a lower edge, and left and right side edges integrally connecting the upper edge and lower edge to form a surface;
a notch extending from at least one of: a left side edge, a right side edge, or the lower edge towards the upper edge; and
the notch being configured to have a top surface and at least one side surface, the notch extending inwards from an outer edge of the surface of the blade.

10. The shovel blade of claim 9, wherein an openness of the notch distal to the upper edge of the blade is configured to gradually decrease to the openness of the top surface proximal to the upper edge.

11. The shovel blade of claim 9, wherein the notch is configured to have at least one of: a parabolic shape, a rectangular shape, a piecewise rectilinear shape, or a piecewise curvilinear shape.

12. The shovel blade of claim 11, wherein the top surface of the notch is concave and projects away from the upper edge.

13. The shovel blade of claim 9, wherein an openness of the notch at one end is configured to be equal to or greater than the openness of the notch at an opposite end.

14. The shovel blade of claim 9, wherein the notch is a spade-shaped cut-out.

15. A method of making a blade for digging, shoveling, or excavation, comprising:
forming a blade configured to have at least an upper edge, a lower edge, and left and right side edges integrally connecting the upper edge and lower edge to form a surface;
forming a notch on at least one of: the left side edge, the right side edge, or the lower edge of the blade;
forming a top surface and at least one side surface for the notch, wherein at least a portion of the notch extends inwards from a peripheral edge of the surface of the blade.

16. The method of claim 15, wherein an openness of the notch distal to the upper edge of the blade is configured to gradually decrease to the openness of the top surface proximal to the upper edge to prevent cutting, scratching or abrasion to the obstacle when positioned between the notch.

17. The method of claim 15, wherein the notch is configured to have at least one of:
a parabolic shape, a rectangular shape, a piecewise rectilinear shape, or a piecewise curvilinear shape.

18. The method of claim 15, wherein the top surface of the notch is concave and projects away from the upper edge of the blade.

19. The method of claim 15, wherein the notch is a leaf shaped cut-out.

20. The method of claim 15, wherein the notch is a spade-shaped cut-out.
